(19) United States
(12) Patent Application Publication
(10) Pub. No.: US 2026/0116096 A1
(43) Pub. Date: Apr. 30, 2026

(54) IMAGE FORMING APPARATUS

(71) Applicant: CANON KABUSHIKI KAISHA, Tokyo (JP)

(72) Inventor: TAKEHARU IIJIMA, Tokyo (JP)

(21) Appl. No.: 19/371,819

(22) Filed: Oct. 28, 2025

(30) Foreign Application Priority Data
Oct. 31, 2024 (JP) 2024-192529

(51) Int. Cl. B41J 11/00; B41J 29/02; B41J 29/06

(52) U.S. Cl. CPC B41J 11/007; B41J 29/02; B41J 29/06

(57) ABSTRACT

An image forming apparatus includes a main assembly, an image forming portion, a belt conveying device, a slide rail extended along a movement direction from a first position toward a second position of the belt conveying device so as to pass through a region enclosed by an inner peripheral surface of the belt, a slide rail supporting member for supporting the slide rail, a supporting beam mounted to the belt conveying device and extended along the movement direction so as to oppose an outer peripheral surface of the belt; and a rotatable supporting member mounted to the main assembly and configured to support the belt conveying device by supporting the supporting beam when the belt conveying device is moved from the first position toward the second position.

### BACKGROUND

### Field of the Technology

The present disclosure relates to an image forming apparatus, such as a printing machine, a copying machine, or a printer, including a belt conveying device and for performing image formation by utilizing an ink jet type.

### Description of the Related Art

Conventionally, as the image forming apparatus of the ink jet type (ink jet recording apparatus) which ejects ink droplets on a recording medium such as recording paper or a resin sheet and which thus records an image such as a character, there is an ink jet recording apparatus of a line head type. In this recording apparatus, in a state in which a recording head is not moved relative to an image forming apparatus main assembly, in association with conveyance of the recording medium, liquid droplets of different colors are ejected from a plurality of recording heads, so that a color image is recorded on the recording medium. Further, as the ink jet recording apparatus of the line head, a recording apparatus in which conveyance of the recording medium relative to the recording heads is performed by using a print belt constituted by an endless belt has been known. The print belt is stretched by a plurality of stretching rollers, and the recording medium is attracted to a conveying surface which is a surface formed between the stretching rollers on sides upstream and downstream of the recording heads and is conveyed.

In the print belt is abraded with drive, and therefore, there is a need to exchange the print belt, for example, periodically.

For that reason, a constitution in which a slide rail is provided so as to penetrate through a region enclosed by an inner peripheral surface of the print belt in a belt conveying device for supporting and conveying the print belt and in which the belt conveying device is capable of being pulled out from an image forming apparatus main assembly has been known.

However, in the case where the slide rail is disposed so as to penetrate through the region enclosed by the inner peripheral surface of the print belt, a slide rail supporting member for fixing the slide rail to the image forming apparatus main assembly can only fix the slide rail to the image forming apparatus main assembly in an end portion of the slide rail with respect to a longitudinal direction. For that reason, when the belt conveying device is pulled out, large moment is exerted on the slide rail supporting member, so that there is a possibility that the slide rail supporting member and further the slide rail are largely deformed by exceeding a tolerable amount. By this, there is a liability that the belt conveying device is moved largely downward by exceeding a tolerable amount and a defect such that an element of the belt conveying device such as the print belt is broken or the like occurs.

In Japanese Laid-Open Patent Application No. 2003-302801, in order to suppress sink of the belt conveying device when the belt conveying device is pulled out, a constitution in which a holding frame, including rollers, connected to the belt conveying device and supporting the slide rail supporting member by being moved together with the belt conveying device is disclosed.

When a movement supporting unit for supporting the slide rail supporting member moved together with the belt conveying device as described above is in a state in which the belt conveying device is sufficiently pulled out, a large effect is achieved. This is because the movement supporting unit is sufficiently pulled out together with the belt conveying device and is capable of supporting an end portion of the slide rail supporting member on a side opposite from a side where the slide rail supporting member is fixed to the image forming apparatus main assembly.

However, for example, in a state in which the belt conveying device is slightly pulled out or in the like state, a position where the movement supporting unit supports the slide rail supporting member is the neighborhood of the end portion of the slide rail supporting member on the side where the slide rail supporting member is fixed to the image forming apparatus main assembly. For that reason, the end portion of the slide rail supporting member on the opposite side cannot be supported by the movement supporting unit. As a result, there is a possibility that the slide rail supporting member and further the slide rail and largely deformed and thus the belt conveying device is largely moved downward by exceeding the tolerable amount.

### SUMMARY

The present disclosure is directed to suppress that when a belt conveying device is provided out from an image forming apparatus main assembly, the belt conveying device is largely moved downward by exceeding a tolerable amount.

This is achieved by an image forming apparatus according to the present disclosure.

According to an aspect of the present invention, there is provided an image forming apparatus comprising: a main assembly; an image forming portion provided to the main assembly and configured to form an image on a sheet; a belt conveying device provided to the main assembly and provided with a rotatable endless belt for carrying and conveying the sheet and with a plurality of stretching rollers for stretching the belt, the belt conveying device being movable along a movement direction crossing a conveying direction of the belt between a first position for operating the belt conveying device and a second position on an outside of the main assembly relative to the first position; a slide rail configured to movably support the belt conveying device along the movement direction, and extended along the movement direction from the first position toward the second position of the belt conveying device so as to pass through a region enclosed by an inner peripheral surface of the belt; a slide rail supporting member configured to support the slide rail and supported by the main assembly on a side upstream of the belt conveying device with respect to the movement direction; a supporting beam mounted to the belt conveying device and extended along the movement direction so as to oppose an outer peripheral surface of the belt; and a rotatable supporting member mounted to the main assembly and configured to support the belt conveying device by supporting the supporting beam when the belt conveying device is moved from the first position toward the second position.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of the image forming apparatus.

FIG. 2 is a schematic perspective view of a print belt unit as viewed from a front side.

FIG. 3 is a schematic perspective view of a main body frame, the print belt unit, and the like as viewed from the front side.

FIG. 4 is a schematic perspective view of the print belt unit as viewed from below.

FIG. 5 is a schematic perspective view showing the main body frame, a slide rail supporting member, and the like as viewed from the front side.

FIG. 6A is a schematic perspective view showing the main body frame, the print belt unit, and the like as viewed from a rear side.

FIG. 6B is a schematic perspective view showing the main body frame, the print belt unit, and the like as viewed from the rear side.

Parts (a) and (b) of FIG. 7 are schematic views of a constitution of a comparison example and a constitution of an embodiment, respectively.

FIG. 8 is a schematic perspective view of the print belt unit as viewed from the rear side.

FIG. 9 is a schematic perspective view of the print belt unit when a print belt is exchanged.

Parts (a) and (b) of FIG. 10 are schematic perspective views showing a front-side mounting portion of a lower beam.

Parts (a) and (b) of FIG. 11 are schematic perspective views showing a rear-side mounting portion of the lower beam.

Parts (a) and (b) of FIG. 12 are schematic perspective views for illustrating a change in state of the lower beam due to pulling-out of the print belt unit.

Parts (a) and (b) of FIG. 13 are schematic views each for illustrating another example of a supporting beam.

### DESCRIPTION OF THE EMBODIMENTS

In the following, an image forming apparatus according to the present disclosure will be described further specifically with reference to the drawings.

### Embodiment 1

### Image forming apparatus

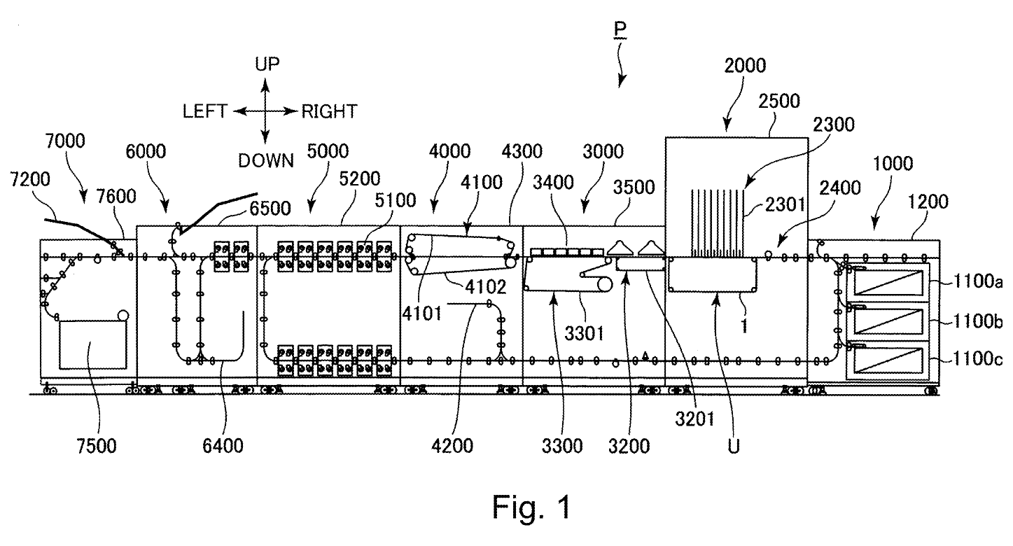

First, a general constitution of an image forming apparatus according to this embodiment will be described. The image forming apparatus of this embodiment is an ink jet recording apparatus P of a line head type utilizing an ink jet type. FIG. 1 is a schematic sectional view showing a general constitution of the ink jet recording apparatus P of this embodiment. This ink jet recording apparatus P is a sheet type ink jet recording apparatus in which an ink image is formed on a sheet S such as out plain paper, which is a recording medium (recording material, sheet) by using two liquids, as liquids for recording, consisting of a reaction liquid and ink and then a recording product is outputted.

Incidentally, in the following description, the ink jet recording apparatus P is assumed to be installed on a horizontal surface. Further, as regards the ink jet recording apparatus P and elements thereof, on the drawing sheet of FIG. 1, a front side is referred to as a "front (front surface)" side, a rear side is referred to as a "rear (rear surface)" side, a right side is referred to as a "right" side, a left side is referred to as a "left" side, an upper side is referred to as an "upper (UP)" side, and a lower side is referred to as a "lower (DOWN)" side. A front-rear direction is perpendicular to a left-right direction and an up-down direction. In the case where the ink jet recording apparatus P is installed on the horizontal surface, the up-down direction is parallel to a gravitational direction (vertical direction). However, as regards the ink jet recording apparatus P and the elements thereof, the "up" and the "down" do not mean only "immediately above", and "immediately below", respectively, and include an "upper side" and a "lower side", respectively, with respect to a horizontal surface passing through a noticed element or a noticed position.

Further, in the following description, the sheet S is referred to as paper, but the sheet S includes a material other than paper, or those (synthetic paper and film formed using synthetic resin, metalized paper having a metal layer, and the like) formed of a material containing the material other than the paper. Further, for convenience, the liquid for recording, such as the reaction liquid or the ink is simply referred to as "ink", but may also be an arbitrary liquid, such as a reaction liquid or ink, used for image recording.

The ink jet recording apparatus P includes modules (sheet processing portion) including a sheet (paper) feeding module 1000, a print module 2000, a drying module 3000, a fixing module 4000, a cooling module 5000, a reversing module 6000, and a sheet (paper) discharge stacking module 7000. A cut paper-like sheet S fed from the sheet feeding module 1000 is conveyed along a conveying path and processed by the respective modules, and then is guided to the sheet discharge stacking module 7000.

The sheet feeding module 1000 includes three accommodating boxes 1100a, 1100b, and 1100c for accommodating sheets S, and a casing 1200 in which these boxes are accommodated, and the like member. Each of the accommodating boxes 1100a, 1100b, and 1100c is constituted so as to be capable of being pulled out toward a front side relative to the casing 1200. The sheets S are fed from each of the accommodating boxes 1100a, 1100b, and 1100c one by one by a separation belt and conveying rollers, and the fed sheet S is conveyed toward the print module 2000. Incidentally, the number of the accommodating boxes is not limited to three, but may also be one, two, or four or more.

The print module 2000 includes a registration correcting portion (pre-image formation registration correcting portion) 2400, a print belt unit U as a belt conveying device, a recording portion (image forming portion) 2300, a casing 2500 for accommodating therein these members, and the like. The sheet S conveyed from the sheet feeding module 1000 to the print module 2000 is corrected in inclination and position thereof by the registration correcting portion 2400 and is conveyed toward the print belt unit U. The recording portion 2300 is disposed in a position opposing the print belt unit U while sandwiching a conveying path of the sheet S therebetween. The recording portion 2300 form an image on the sheet S by subjecting the sheet S, conveyed by the print belt unit U to recording processing (image formation, printing, print) from above by a recording head 2301. The sheet S is ensured to form a clearance between itself and the recording head 2301 by being attracted and conveyed by a print belt 1 of the print belt unit U. A conveying direction of the sheet S by the print belt unit U is a direction from a left side toward a right side. Further, the recording portion 2300 includes a plurality of recording heads (line type recording heads) 2301 arranged along the conveying direction of the sheet S. In this embodiment, the recording portion 2300 includes eight recording heads 2301, as the plurality of recording heads 2301, corresponding to four colors of Y (yellow), M (magenta), C (cyan), and Bk (black), three colors which is particular colors such as white and neon color, and a reaction liquid. Incidentally, the number of the colors and the number of the recording heads 2301 are not limited to eight. As the ink jet type of the recording heads 2301, it is possible to employ a type using heat generating elements, a type using piezoelectric elements, a type using electrostatic elements, a type using MEMS elements, and the like type. Each of the color inks is supplied from an ink tank provided to the print module 2000 to the corresponding recording head 2301 through an ink tube, for example. The sheet S subjected to recording processing by the recording portion 2300 is conveyed by the print belt unit U and passes through an in-line scanner (not shown) provided on a side downstream of the recording portion 2300 with respect to the conveying direction of the sheet S. The ink jet recording apparatus P is capable of correcting a print image on the basis of deviation and color density of the image formed on the sheet S, detected by the in-line scanner.

The drying module 3000 includes a decoupling portion 3200, a drying belt unit 3300, a warm air blowing portion 3400, a casing 3500 accommodating these members therein, and the like. The drying module 3000 reduces a liquid component contained in the ink supplied onto the sheet S in the recording portion 2300 and enhances a fixing property between the sheet S and the ink. The sheet S subjected to the recording processing by the recording portion 2300 of the print module 2000 is conveyed to the decoupling portion 3200 disposed in the drying module 3000. The decoupling portion 3200 is capable of conveying the sheet S by air pressure from above and friction of the decoupling portion 3200 with a belt 3201. In the decoupling portion 3200, the sheet S on the belt 3201 is conveyed while being weakly held, so that deviation of the sheet S, on which an ink image is formed, on the print belt 1 of the print belt unit U can be prevented. The sheet S conveyed from the decoupling portion 3200 to the drying belt unit 3300 is sucked and conveyed by a belt 3301 of the drying belt unit 3300. Simultaneously therewith, hot air is supplied from the warm air blowing portion 3400 disposed above the belt 3301 of the drying belt unit 3300, so that the surface of the sheet S on which the ink is supplied is dried. Incidentally, as a drying type, it is possible to use, in addition to the type of supplying the hot air, a type irradiating the surface of the sheet S with electromagnetic radiation (such as ultraviolet radiation or infrared radiation) and a conductive heat transfer type by contact of a heat generating member. These types may be combined arbitrary.

The fixing module 4000 includes a fixing belt unit 4100 and a casing 4300 accommodating the fixing belt unit 4100. The fixing module 4000 is capable of fixing the ink on the sheet S by passing the sheet S, conveyed from the drying module 3000 to the fixing module 4000, through between an upper belt unit 4101 and a lower belt unit 4102 which are heated.

The cooling module 5000 includes a plurality of cooling portions 5100 and a casing 5200 accommodating these cooling portions 5100. The cooling module 5000 cools the sheet S conveyed from the fixing module 4000 to the cooling module 5000 and high in temperature. The cooling portion 5100 takes external air into a cooling box and increases pressure in the cooling box, and is constituted so as to cool the sheet S by blowing wind, jetted from nozzles formed on a conveying guide. The cooling portion 5100 is disposed on each of opposite sides while sandwiching a conveying path of the sheet S, and is capable of cooling the sheet S from the opposite sides. Further, in the cooling module 5000, a switching portion for switching the conveying path of the sheet S is provided. This switching portion is capable of switching the conveying path of the sheet S depending on the case where the sheet S is conveyed to the reversing module 6000 and the case where the sheet S is conveyed to a double-side conveying path used during double-side printing. During the double-side printing, the sheet S is conveyed to the double-side conveying path provided in a lower portion of the cooling module 5000 and is further conveyed along the double-side conveying path provided in lower portion of the fixing module 4000, the drying module 3000, the print module 2000, and the sheet feeding module 1000. By this, the sheet S is convey again toward the registration correcting portion 2400 of the print module 2000, the print belt unit U, and the recording portion 2300, and is subjected to the recording processing by the recording portion 2300. Incidentally, the double-side conveying path of the fixing module 4000 is provided with a first reversing portion 4200 for turning the sheet S upside down, and the first reversing portion 4200 is configured so as to be capable of conveying the sheet S again toward the recording portion 2300 after the sheet S is turned upside down during the double-side printing.

The reversing module 6000 includes a second reversing portion 6400, a casing 6500 accommodating this second reversing portion 6400, and the like. The reversing module 6000 is capable of turning the sheet S, conveyed from the cooling module 5000 to the reversing module 6000, upside down and is capable of freely changing front/rear surfaces (sides) of and a direction of leading/trailing ends, with respect to the conveying direction, of the sheet S to be discharged from the reversing module 6000.

The sheet discharge stacking module 7000 includes a top tray 7200, a stacking portion 7500, a casing 7600 provided with these portions 7200 and 7500, and the like. The sheet discharge stacking module 7000 is capable of aligning sheets conveyed from the reversing module 6000 to the sheet discharge stacking module 7000 and then discharging and stacking the sheets onto the top tray 7200 or stacking and accommodating the sheets S into the stacking portion 7500.

### Print belt unit

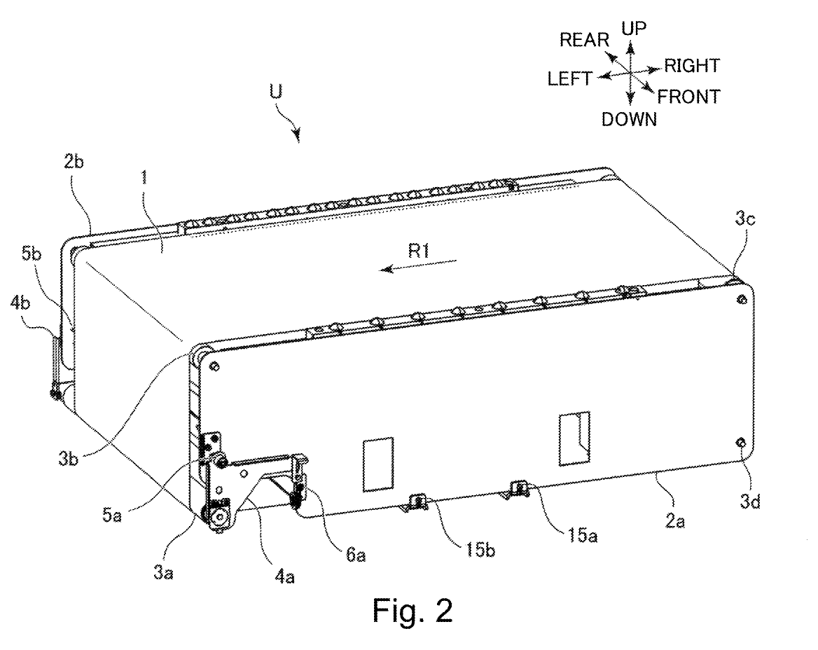

Next, a schematic constitution of the print belt unit U will be described. FIG. 2 is a schematic perspective view of the print belt unit as viewed from a front side.

The print belt unit U includes a front-side plate 2a as a front-side supporting structure, a rear-side plate 2b as a rear-side supporting structure, first, second, third, and fourth stretching rollers 3a, 3b, 3c, and 3d as a plurality of stretching rollers (supporting rollers), and the print belt 1. The four stretching rollers 3a to 3d are connected to the front-side plate 2a and the rear-side plate 2b through bearings, leaf springs, or the like. The print belt (conveying belt) 1 is constituted by an endless belt is extended around four stretching rollers 3a to 3d and is stretched with predetermined tension. The print belt 1 is constituted by using a resin material or a metal material. Further, for example, a size of the print belt 1 with respect to a widthwise direction (direction substantially perpendicular to a surface movement direction) is set so that a sheet S having a B3 size (364mm x 515mm) can be fed laterally (conveyed so that a short side extends in a direction along the conveying direction).

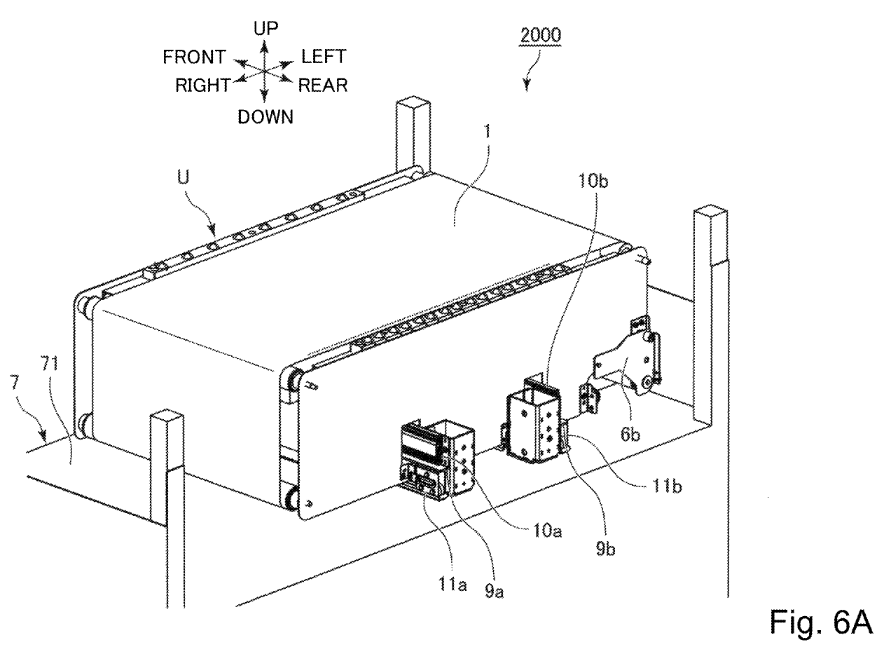

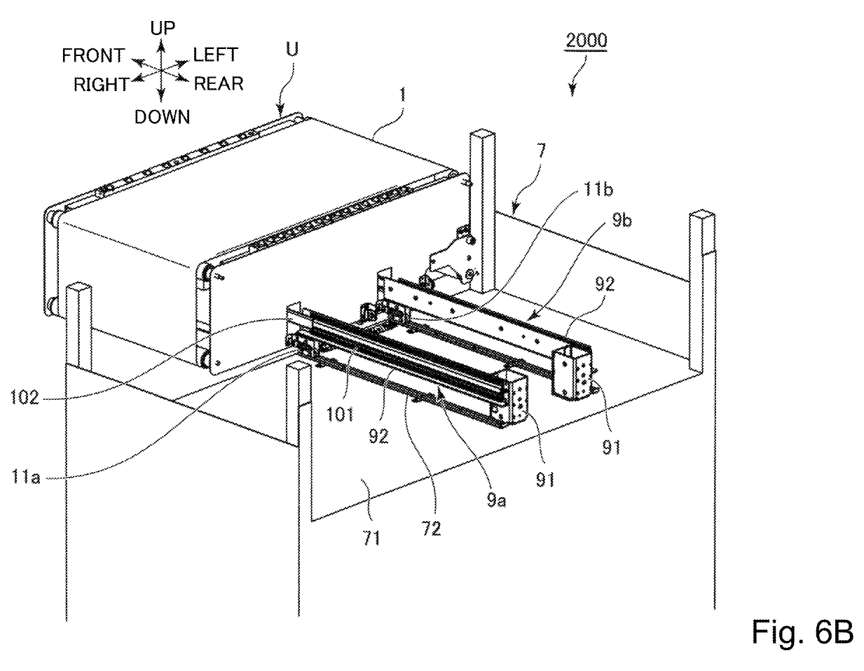

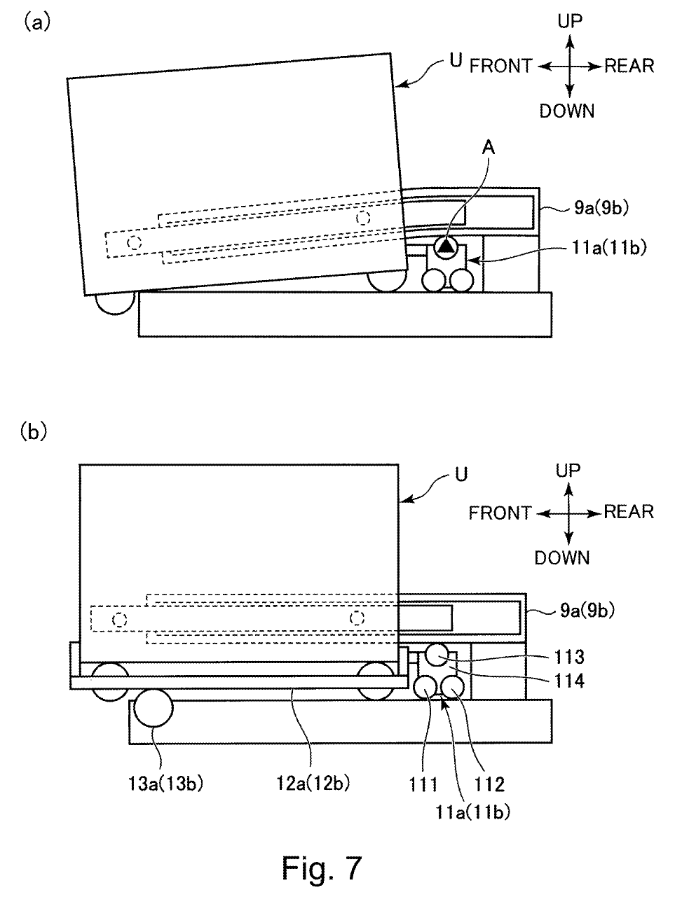

In this embodiment, the first stretching roller 3a has a function as a tension roller for imparting tension to the print belt 1. The first stretching roller 3a is connected to the front-side plate 2a and the rear-side plate 2b through a front supporting metal plate 4a and a rear supporting metal plate 4b, respectively. The front supporting metal plate 4a is supported by the front-side plate 2a rotatably about a front supporting metal plate rotation shaft 5a. The rear supporting metal plate 4b is supported by the rear-side plate 2b rotatably about a rear supporting metal plate rotation shaft 5b. The first stretching roller 3a is rotatably supported by the front supporting metal plate 4a and the rear supporting metal plate 4b are urged in a direction in which these plates are rotated so as to move the first stretching roller 3a to an outside the print belt 1 under application of a spring force (springs are not shown) to spring force applying portions 6a and 6b (FIG. 2, FIG. 6A). By this, tension is imparted to the print belt 1 by the first stretching roller 3a.

In this embodiment, the second stretching roller 3b has a function as a driving roller for driving the print belt 1. The second stretching roller 3b is rotated by transmitting thereto a driving force from a motor (not shown) as a driving source constituting a driving means, so that the driving force is transmitted to the print belt 1. By this, the print belt 1 is rotated (circulated and moved) in an arrow R1 direction in FIG. 2.

The sheet S is attracted to and conveyed on a conveying surface of the print belt 1 stretched and formed by the third stretching roller 3c and the second stretching roller 3b. The first stretching roller 3a is disposed on a side downstream of the second stretching roller 3b and upstream of the fourth stretching roller 3d with respect to a rotational direction (circumferential movement direction) of the print belt 1. The fourth stretching roller 3d is disposed on a side downstream of the first stretching roller 3a and the third stretching roller 3c with respect to the rotational direction of the print belt 1. The stretching rollers 3a, 3c, and 3d other than the second stretching roller 3b are rotated with rotation of the print belt 1.

Incidentally, in the print belt unit U, in a region enclosed by an inner peripheral surface of the print belt 1, for example, other many elements such as platen unit and the like for supporting the print belt 1 in a region opposing the recording heads 2301 of the recording portion 2300 are disposed.

Further, the number of stretching rollers for the print belt 1 is not limited to four, but may also be two, three, or more than four.

Here, the print belt 1 is abraded with drive, and therefore, is required to be exchanged, for example, periodically.

### Print belt unit supporting constitution

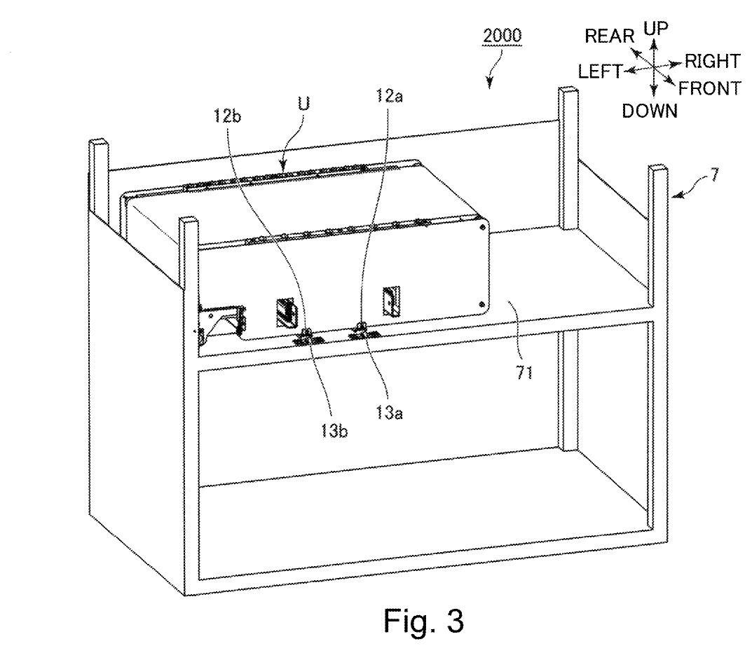

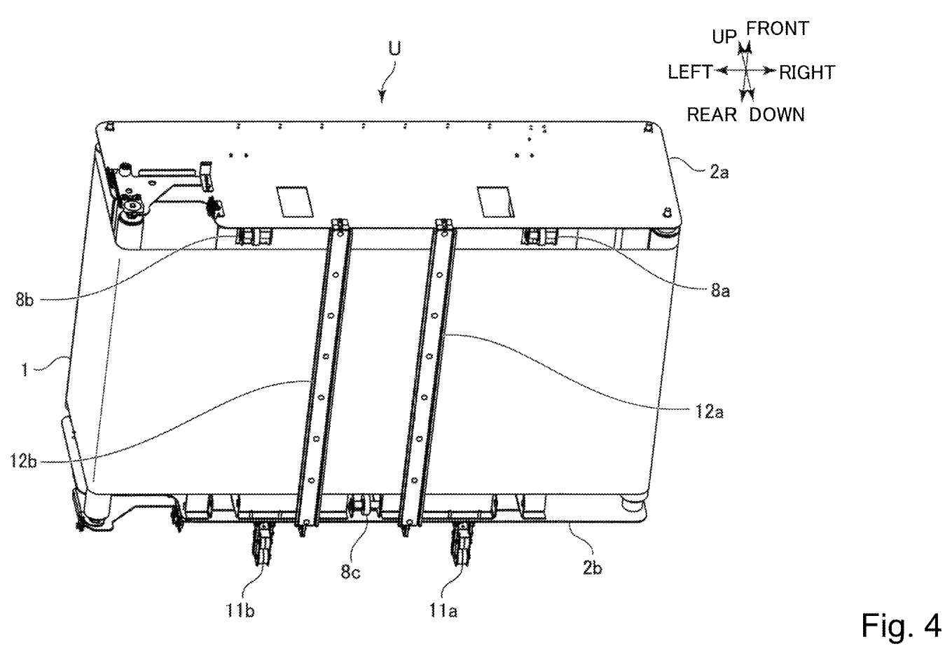

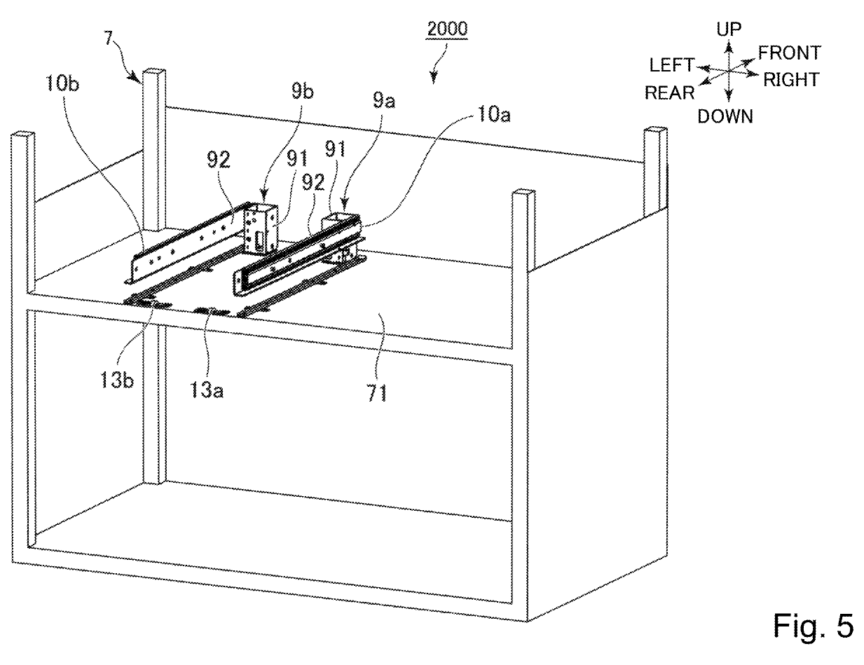

Next, a supporting constitution of the print belt unit U in this embodiment will be described. FIG. 3 is a schematic perspective view showing a part of a constitution (main body frame 7, print belt unit, and the like) of the print module 2000 as viewed from the front side. FIG. 4 is a schematic perspective view of the print belt unit U as viewed from a lower side. FIG. 5 is a schematic perspective view showing a part of constitution (main body frame 7, slide rail supporting member 8, and the like) of the print module 2000 as viewed from the front side. Further, FIG. 6A and FIG. 6B are schematic perspective views showing a part of constitution (main body frame 7, print belt unit U, and the like) of the print module 2000 as viewed from the rear side.

As shown in FIG. 3, during printing, the print belt unit U is mounted to the main body frame 7 as a supporting structure (frame body, frame) provided in the print module 2000 and is used in a fixed state. In this embodiment, the main body frame 7 constitutes the image forming apparatus main assembly and supports elements of the print module 2000 such as the print belt unit U. The main body frame 7 includes a supporting table (base) 71 provided substantially horizontally. As shown in FIG. 4, the print belt unit U is provided with first, second, and third grounding rollers 8a, 8b, and 8c as a plurality of rotatable grounding members in a lower portion thereof. In this embodiment, the first and second grounding rollers 8a and 8b are provided on the front side and are connected to the front-side plate 2a. In addition, in this embodiment, the third grounding roller 8c is provided on the rear side, and is connected to the rear-side plate 2b. The print belt unit U is grounded to an upper surface of the supporting table 71 of the main body frame 7 by the first, second, and third grounding rollers 8a, 8b, and 8c. Incidentally, the print belt unit U may be provided with two grounding rollers on the rear side, and may be provided with one grounding roller on the front side. Further, the number of the grounding rollers is not limited to three, but four or more grounding rollers may also be provided. In the case where the four or more grounding rollers are provided, during the printing, a constitution in which only to three rollers are grounded to the supporting table 71 of the main body frame 7 may be employed.

In a state in which the print belt unit U is grounded to the main body frame 7, removal of the print belt 1 from the print belt unit U, i.e., pulling-out of the print belt 1 from the plurality of stretching rollers along the widthwise direction (direction substantially perpendicular to a surface movement direction) cannot be performed. For that reason, the print belt unit U is constituted so as to be capable of being pulled out from the main body frame 7 to the front side. Specifically, as shown in FIG. 5, the main body frame 7 is provided with, as a plurality of slide rail supporting members, first and second slide rail supporting members 9a and 9b. Further, first and second slide rails 10a and 10b which are two sets of slide rails 10a and 10b capable of being expanded and contracted in the front-rear direction are connected to the main body frame 7 through the first and second slide rail supporting members 9a and 9b, respectively. Each of the first and second slide rail supporting members 9a and 9b includes a base portion 91 and a fixing portion 92. The base portion 91 is fixed to the supporting table 71 of the main body frame 7 in a rear-side position than the rear-side plate 2b in a state in which the print belt unit U is disposed in a position (first position, print position) during the printing (FIG. 6A). The fixing portion 92 extends along (in this embodiment, substantially parallel to) the front-rear direction, and a rear-side end portion thereof with respect to the longitudinal direction is fixed to the base portion 91.

As the first and second slide rails 10a and 10b, for example, slide rails having available arbitrary constitutions, such as known slide rails can be used. In this embodiment, constitutions of the first and second slide rails 10a and 10b are substantially the same. Here, in the case where the first and second slide rails 10a and 10b are described without being particularly distinguished, these first and second slide rails 10a and 10b are referred to as "slide rail(s) 10" by omitting suffixes "a" and "b" of the reference numerals (symbols) in some instances. The same applies to "a" and "b" added to other pluralities of elements such as the first and second slide rail supporting members 9a and 9b. The slide rail 10 includes at least a first rail member (outer member) 101 fixed to the main body frame 7 and a second rail member (inner member) 102 fixed to the print belt unit U (FIG. 6B). The first rail member 101 and the second rail member 102 are engaged so as to be movable relative to each other. The first rail member 101 is fixed to the fixing portion 92 of the slide rail supporting member 9 along (in this embodiment, substantially parallel to) the front-rear direction. Further, the second rail member 102 is fixed to the print belt unit U by being engaged with a unit-side fixing portion (not shown) of the print belt unit U connected to the front-side plate 2a and the rear-side plate 2b. The second rail member 102 is moved together with the print belt unit U relative to the first rail member 101, so that the slide rail 10 can be expanded and contracted in the front-rear direction. Further, in this embodiment, the slide rail 10 includes a third rail member (intermediary member) (not shown) provided between the first rail member 101 and the second rail member 102 so that the print belt unit U can be substantially completely pulled out from the main body frame 7. The third rail member is moved relative to the first rail member 101, and in addition, the second rail member 102 is moved relative to the third rail member, so that the slide rail 10 can be expanded (extended) to a length, with respect to the longitudinal direction, which is substantially two times a length in a contracted state thereof. By this, the print belt unit U can be pulled out to an outside of the main body frame 7 substantially completely. Incidentally, between the rail members constituting the slide rail 10, ball bearings or rollers may also be provided.

Incidentally, when desired maintenance of the print belt unit U such as exchange of the print belt 1 can be performed, the print belt unit U is not necessarily required to be substantially completely pulled out from the main body frame 7. When the print belt unit U is made pullable out to at least a state in which the first and second grounding rollers 8a and 8b provided on a front side of the print belt unit U are not grounded to the main body frame 7, the print belt 1 can be removed by being pulled out to the front side. However, when mounting of the print belt 1 by inserting the print belt 1 into the rear side or the like is taken into consideration, the print belt unit U may preferably be substantially completely pulled out from the main body frame 7.

FIG. 6A shows a state in which the print belt unit U is disposed in the position (first position, print position) on the main body frame 7 during the printing. Further, FIG. 6B shows a state in which the print belt unit U is disposed in a position (second position, pulling-out position) where the print belt 1 is pulled out so as to be capable of being exchanged. In this embodiment, the pulling-out position is a position in which the print belt 1 is substantially completely pulled out from the main body frame 7 toward the front side. In this embodiment, when the print belt unit U is in the print position, each of the first, second, and third grounding rollers 8a, 8b, and 8c is grounded to the supporting table 71 of the main body frame 7. Further, in this embodiment, when the print belt unit U is in the pulling-out position, each of the first, second, and third grounding rollers 8a, 8b, and 8c is positioned on a front side than the supporting table 71 of the main body frame 7 and is not grounded to the supporting table 71. The print belt unit U is movable between the print position and the pulled out along (in this embodiment, substantially parallel to) the front-rear direction.

Thus, the print belt unit U is movable along a direction crossing (in this embodiment, substantially perpendicular to) the conveying direction of the print belt 1 between the first position (print position) when the sheet S is conveyed and the second position (pulled-out position) outside the main body frame (apparatus main assembly) 7 relative to the first position. Particularly, in this embodiment, in a state in which the print belt unit U is disposed in the second position, a whole of the sprint belt 1 is positioned outside the main body frame (apparatus main assembly) 7 with respect to the above-described movement direction (pulling-out direction).

As shown in FIG. 6A, the first and second slide rails 10a and 10b are extended so as to penetrate through a region enclosed by the inner peripheral surface of the print belt 1 in order to permit exchange of the print belt 1. Further, for that purpose, the fixing portions 92 of the slide rail supporting members 9a and 9b are provided so as to penetrate through the region enclosed by the inner peripheral surface of the print belt 1. Incidentally, front-side end portions of the first and second slide rails 10a and 10b are not necessarily be provided so as to penetrate through the print belt unit U to the front side than the print belt unit U. However, in order that the print belt unit U can be pulled out from the main body frame 7 substantially completely, the first and second slide rails 10a and 10b may preferably be provided so as to penetrate through the print belt unit U. Further, in this embodiment, to a rear portion of the print belt unit U, as a plurality of movement supporting units (roller units), first and second movement supporting units 11a and 11b for supporting the first and second slide rail supporting members 9a and 9b, respectively, are connected. The first and second movement supporting units 11a and 11b are disposed on a rear side than the rear-side plate 2b. The first movement supporting unit 11a is provided so as to be sandwiched between the fixing portion 92 of the first slide rail supporting member 9a and the supporting table 71 of the main body frame 7. Similarly, the second movement supporting unit 11b is provided so as to be sandwiched between the fixing portion 92 of the second slide rail supporting member 9b and the supporting table 71 of the main body frame 7. The first and second movement supporting units 11a and 11b are movable together with the print belt unit U in the front-rear direction.

In this embodiment, each of the first and second movement supporting units 11a and 11b includes first, second, and third movement supporting rollers 111, 112, and 113, and a movement supporting frame 114 (part (b) of FIG. 7). Each of the first and second movement supporting rollers 111 and 112 is an example of a rotatable supporting member traveling on the supporting table 71 of the main body frame 7. The third movement supporting roller 113 is an example of a rotatable supporting member traveling on the fixing portion 92 of an associated one of the first and second slide rail supporting members 9a and 9b. Further, the movement supporting frame 114 is an example of a supporting structure for rotatably supporting the first, second, and third movement supporting rollers 111, 112, and 113. Incidentally, on the supporting table 71 of the main body frame 7, a movement supporting rail 72 (FIG. 6B) which is a rail on which an associated one of the first and second movement supporting units 11a and 11b travels may be provided.

As shown in FIG. 6B, when the print belt unit U is substantially completely pulled out from the main body frame 7, the first and second movement supporting units 11a and 11b support front-side end portions of the fixing portions 92 of the first and second slide rail supporting members 9a and 9b, respectively (from below). Accordingly, at this time, by the first and second movement supporting units 11a and 11b, deformation of the fixing portions 92 of the slide rail supporting members 9a and 9b is suppressed, so that it is possible to suppress that the print belt unit U is largely moved downward by exceeding a tolerable amount.

### Outline of problem and solution

As described above, the movement supporting unit 11 supporting the slide rail supporting member 9 by being moved together with the print belt unit U exhibits a large effect when the print belt unit U is in a state in which the print belt unit U is sufficiently pulled out. However, for example, in a state in which the print belt unit U is slightly pulled out or in the like state, the effect is not sufficiently achieved, so that there is a possibility that the slide rail supporting member 9 and further the slide rail 10 are largely deformed by exceeding a tolerable amount.

Part (a) of FIG. 7 is a schematic view of a constitution of a comparison example. Incidentally, also in the constitution of the comparison example, elements having functions or constitutions identical or corresponding to those in this embodiment are represented by the same reference numerals or symbols. Also, in the constitution of the comparison example, the fixing portion 92 of the slide rail supporting member 9 is provided so as to penetrate through the region enclosed by the inner peripheral surface of the print belt 1, and a rear-side end portion thereof is fixed to the main body frame 7 through the base portion 91. Further, also in the constitution of the comparison example, the movement supporting unit 11 is connected to a rear portion of the print belt unit U. In this constitution of the comparison example, in the case where the print belt unit U is sufficiently pulled out until the print belt unit U becomes, for example, a state in which the print belt unit is not grounded to the main body frame 7, the front-side end portion of the fixing portion 92 of the slide rail supporting member 9 is supported by the movement supporting unit 11. Further, the rear-side end portion of the fixing portion 92 of the slide rail supporting member 9 is supported by the main body frame 7 through the base portion 91. For that reason, in this state, deformation of the fixing portion 92 of the slide rail supporting member 9 and further deformation of the slide rail 10 are suppressed, so that the print belt unit U is not moved (sunk, hung down) largely downward by exceeding a tolerable amount. However, as shown in part (a) of FIG. 7, for example, in a state in which the print belt unit U is slightly pulled out, the movement supporting unit 11 supports the neighborhood of the rear-side end portion of the fixing portion 92 of the slide rail supporting member 9. For that reason, in this state, the front-side end portion of the fixing portion 92 of the slide rail supporting member 9 is not supported by the movement supporting unit 11. As a result, there is a possibility that by a load of the print belt unit U, the fixing portion 92 of the slide rail supporting member 9 and further the slide rail 10 are deformed largely by exceeding a tolerably amount with a contact portion A as a supporting point. By this, there is a possibility that the print belt unit U is moved largely downward by exceeding the tolerable amount. As a result, for example, there is a possibility that the print belt unit U is not pulled out in contact with the main body frame 7 and that an element of the print belt unit U such as the print belt 1 contacts the main body frame 7 and is broken.

On the other hand, part (b) of FIG. 7 is a schematic view of a constitution of this embodiment. In this embodiment, as described later specifically, the print belt unit U includes, in a lower portion thereof, lower beams 12 (12a, 12b) as a supporting beam so as to bridge the print belt 1 along the front-rear direction on an outer peripheral surface side of the print belt 1. Further, in this embodiment, the main body frame 7 is provided with lower beam supporting rollers 13 (13a, 13b) as a rotatable supporting member for supporting the print belt unit U through the lower beams 12 (from below). According to the constitution of this embodiment, as shown in part (b) of FIG. 7, for example, in a state to an extent such that the print belt unit U is slightly pulled out or in the like state, the print belt unit U is supported through the lower beams 12 by the lower beam supporting rollers 13. For that reason, even when the front-side end portion of the fixing portion 92 of the slide rail supporting member 9 is not supported by the movement supporting unit 11, deformation of the fixing portion 92 of the slide rail supporting member 9 and further deformation of the slide rail 10 are suppressed.

### Constitution of periphery of lower beam

Next, a constitution for suppressing falling (dropping) of the print belt unit U in this embodiment will be further described.

In this embodiment, as shown in FIG. 4, the print belt unit U includes, in the lower portion thereof, first and second lower beams 12a and 12b as the supporting beam. Each of the first and second lower beams 12a and 12b is extended along (in this embodiment, substantially parallel to) the pulling-out direction so as to bridge the print belt 1, without contacting the print belt 1 on the outer peripheral surface side of the print belt 1. The pulling-out direction of the print belt 1 is a direction crossing the conveying direction (surface movement direction) of the print belt unit U, and in this embodiment, is a direction substantially parallel to the front-rear direction and is a direction (direction substantially perpendicular to the conveying direction) substantially parallel to the widthwise direction of the print belt 1. Each of the first and second lower beams 12a and 12b is connected to the front-side plate 2a and the rear-side plate 2b, respectively. In this embodiment, the two lower beams 12 are provided, but when an effect of supporting the print belt unit is sufficient, the number of the lower beams 12 may also be one. Further, in order to achieve a sufficient effect, three or more (for example, three to five) lower beams 12 may also be provided. In this embodiment, each of the first and second lower beams 12a and 12b is constituted by including a main portion and a reinforcing portion for reinforcing the main portion. The main portion is formed by using a 3.2 mm-thick zinc-plated steel plate and by subjecting the plate to bending processing so as to have an U-shaft in cross section substantially perpendicular to the longitudinal direction. Further, the reinforcing portion is formed by a flat plate comprising a 2.0 mm-thick zinc-plated steel plate. The reinforcing portion is fixed to the main portion by spot welding. In this embodiment, the first and second lower beams 12a and 12b are disposed, with respect to the left-right direction, between the first grounding roller 8a and the second grounding roller 8b provided on the front side of the print belt unit U (FIG. 4). Further, in this embodiment, the third grounding roller 8c provided on the rear side of the print belt unit U is disposed between the first lower beam 12a and the second lower beam 12b with respect to the left-right direction (FIG. 4). Further, in this embodiment, the first and second lower beams 12a and 12b are disposed between the first slide rail 10a and the second slide rail 10b with respect to the left-right direction (FIGS. 3 and 4). Further, in this embodiment, with respect to the left-right direction, the first and second slide rails 10a and 10b are disposed between the first grounding roller 8a and the second grounding roller 8b which are provided on the front side of the print belt unit U (FIG. 4). In this embodiment, constitutions of the first and second lower beams 12a and 12b are substantially the same.

Further, in this embodiment, as shown in FIG. 3, the main body frame 7 is provided with the first and second lower beam supporting rollers 13a and 13b as the rotatable supporting member for supporting the print belt unit U through the first and second lower beams 12a and 12b. The first and second lower beam supporting rollers 13a and 13b are provided in the neighborhood of the front-side end portion (edge portion) of the main body frame 7 so as to support the first and second lower beams 12a and 12b when the print belt unit is pulled out. In this embodiment, each of the first and second lower beam supporting rollers 13a and 13b are provided so as to be partially exposed to above from the supporting table 71 in a position on the front side than the front-side plate 2a in a state the print belt unit U is disposed in the print position. That is, in this embodiment, the first and second lower beam supporting rollers 13a and 13b are disposed in positions on the front-side than the first and second lower beams 12a and 12b in the state in which the print belt unit U is disposed in the print position. Each of the first and second lower beam supporting rollers 13a and 13b is rotatable about a rotational axis extending in a direction crossing (in this embodiment, substantially perpendicular to) the pulling-out direction of the print belt unit U. In this embodiment, the first and second lower beam supporting rollers 13a and 13b are supported so that rotation shafts thereof are rotatable relative to first and second bearing members 131a and 131b, respectively (see, part (b) of FIG. 11). Further, the first and second lower beam supporting rollers 13a and 13b are supported by the main body frame 7 by fixing the first and second bearing members 131a and 131b to the main body frame 7. In this embodiment, constitutions of the first and second lower beam supporting rollers 13a and 13b are substantially the same.

As described above, the print belt unit U is capable of being pulled out toward the front side from the print position (FIG. 3 and FIG. 6A) to the pulling-out position (FIG. 6B). When the print belt unit U is in the print position, the front-side end portions of the first and second lower beams 12a and 12b are positioned on the rear side than the first and second lower beam supporting rollers 13a and 13b, respectively. Further, when the print belt unit U is in the pulling-out position, the rear-side end portions of the first and second lower beams 12a and 12b are positioned on the front side than the first and second lower beam supporting rollers 13a and 13b, respectively. At least in a part of movement path from the print out to the pulling-out position, the first and second lower beam supporting rollers 13a and 13b support the print belt unit U through the first and second lower beams 12a and 12b, respectively. In this embodiment, in a substantially whole portion (excluding the case where the print belt unit U is in the print position or the pulling-out position) of the above-described movement path of the print belt unit U, the first and second lower beam supporting rollers 13a and 13b support the print belt unit U through the first and second lower beams 12a and 12b, respectively. Typically, the movement supporting unit 11 achieves an effect of supporting the slide rail supporting member 9 in the case where the movement supporting unit 11 is positioned in a region from a central portion to the front-side end portion of the fixing portion 92 of the slide rail supporting member 9 with respect to the longitudinal direction. The lower beam 12 is provided so as to bridge the front-side plate 2a and the rear-side plate 2b. Further, in this embodiment, the lower beam supporting roller 13 is provided adjacently to the front-side plate 2a on the front side than the front-side plate 2a in a state in which the print belt unit U is disposed in the print unit U is in the print position. For that reason, even in a state in which the print belt unit U is slightly pulled out, i.e., even in a stage before the movement supporting unit 11 becomes to achieve the effect thereof, the lower beam supporting roller 13 starts to support the lower beam 12.

Incidentally, from the above-described viewpoint, in the pulling-out direction of the print belt unit U, the lower beam supporting roller 13 may only be required to be provided on the front side than a center of the fixing portion 92 of the slide rail supporting member 9 with respect to the longitudinal direction. However, in the print position, from a viewpoint that the position of the print belt unit U is determined by the grounding roller 8 or from the like viewpoint, when the print belt unit U is in the print position, it is preferable that the lower beam supporting roller 13 does not support the lower beam 12. Accordingly, as in this embodiment, the lower beam supporting roller 13 may preferably be disposed on the front side than the print belt unit U.

Further, also when the print belt unit U is inserted from the pulling-out position to the print position, the first and second lower beam supporting rollers 13a and 13b are capable of supporting the print belt unit U through the first and second lower beams 12a and 12b, respectively. At this time, operations of the respective portions such as the first and second lower beams 12a and 12b and the first and second lower beam supporting rollers 13a and 13b are reverse to those during the pulling-out of the print belt unit U.

Thus, in this embodiment, the print belt unit U is movable along the direction crossing the conveying direction of the print belt 1 between the first position when the sheet S is conveyed and the second position outside the apparatus main assembly relative to the first position. Further, in this embodiment, the print belt unit U includes the slide rail 10 extended along the movement direction from the first position toward the second position of the print belt unit so s to pass through the region enclosed by the inner peripheral surface of the print belt 1; the slide rail supporting member 9 for supporting the slide rail 10 and supported by the apparatus main assembly on the side upstream of the print belt unit U with respect to the above-described movement direction, the supporting beam (lower beam) 12 mounted to the print belt unit U in each of the upstream-side first end portion and the downstream-side second end portion with respect to the movement direction, and the rotatable supporting member (lower beam supporting roller) 13 provided to the apparatus main assembly and supporting the print belt unit U by supporting the supporting beam 12 when the print belt unit U is moved from the first position toward the second position. That is, according to this embodiment, the print belt unit U is provided with the lower beam 12, and the main body frame 7 is provided with the lower beam supporting roller 13. By this, for example, even in the state in which the print belt unit U is pulled out slightly or the like, by the lower beam supporting roller 13, the print belt unit U can be supported through the lower beam 12. Accordingly, deformation of the fixing portion 92 of the slide rail supporting member 9 and further deformation of the slide rail 10 can be suppressed.

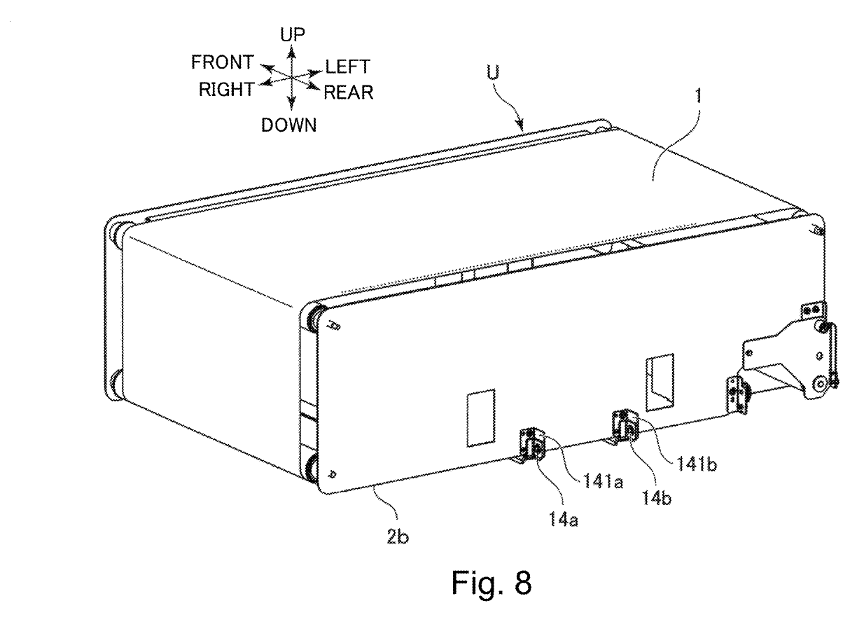

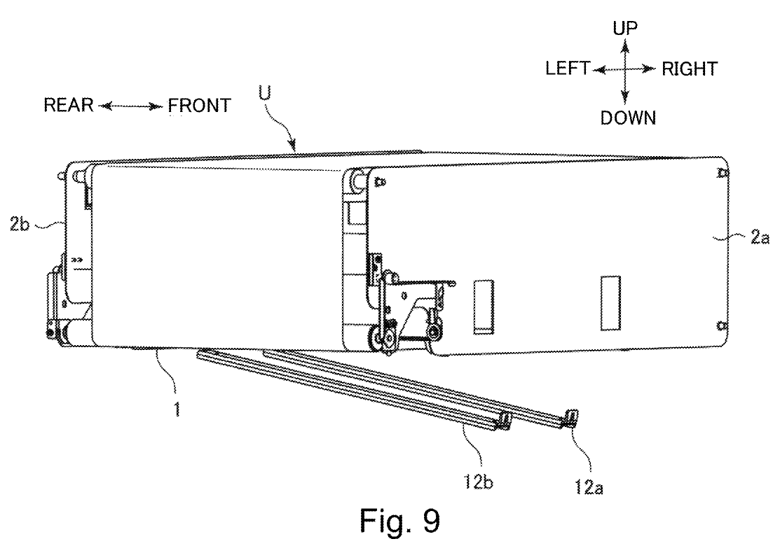

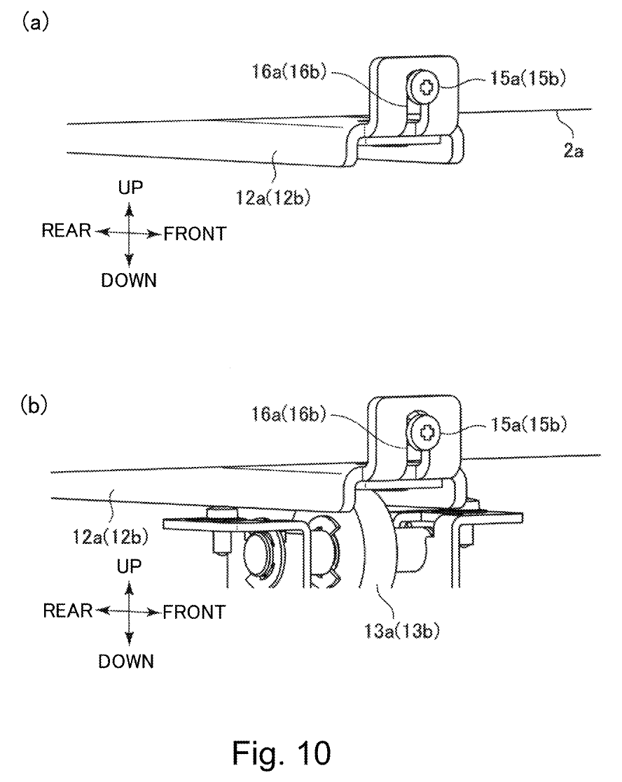

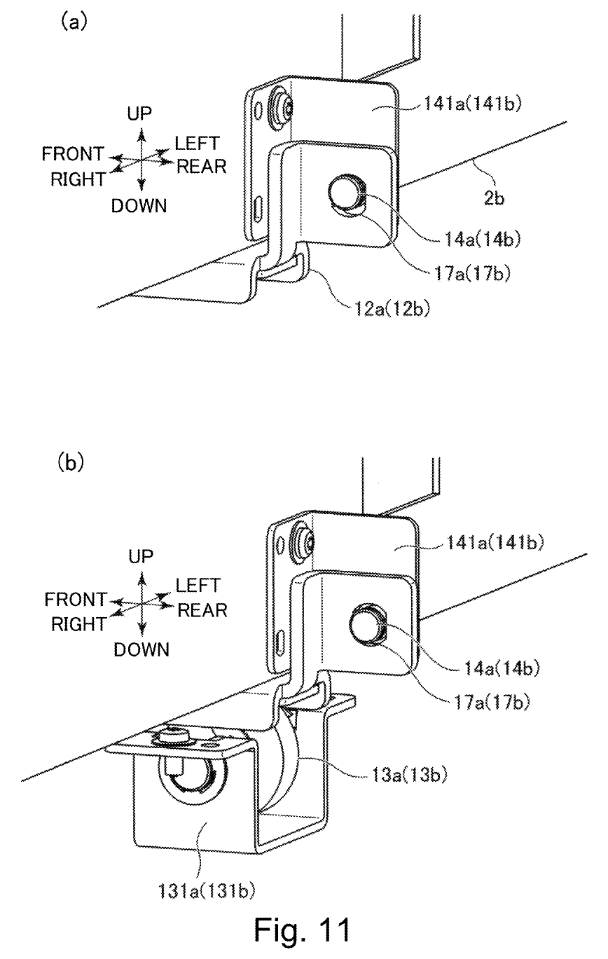

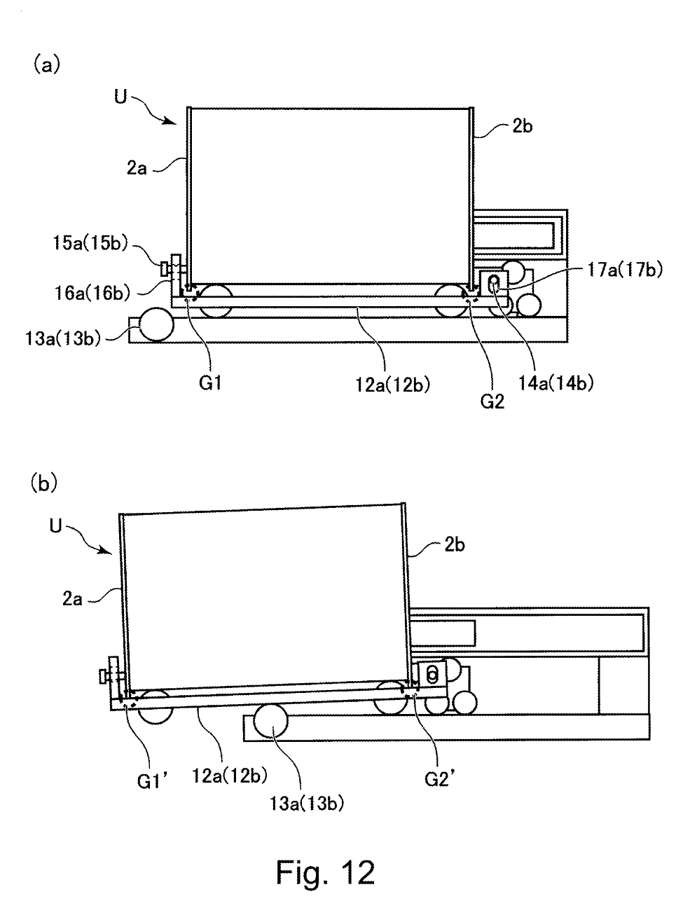

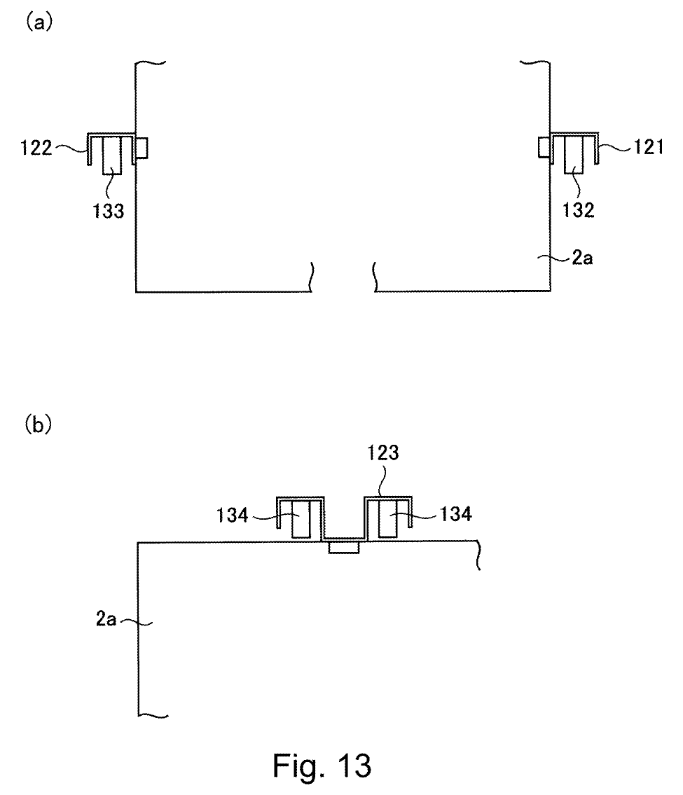

Next, handling of the first and second lower beams 12a and 12b when the print belt 1 is exchanged will be described. FIG. 8 is a schematic perspective view of the print belt unit U as viewed from the rear side. FIG. 9 is a schematic perspective view of the print belt unit U as viewed from the front side, showing a state in which the print belt 1 is exchanged. Parts (a) and (b) of FIG. 10 are schematic perspective views showing a front-side mounting portion of the first lower beam 12a (or second lower beam 12b). Parts (a) and (b) of FIG. 11 are schematic perspective views showing a rear-side mounting portion of the first lower beam 12a (or second lower beam 12b). Further, parts (a) and (b) of FIG. 12 are schematic views for illustrating a change in state of the first lower beam 12a (or second lower beam 12b) by the pulling-out of the print belt unit U. In this embodiment, mounting constitutions of the first and second lower beams 12a and 12b are substantially the same.

As shown in FIG. 8, each of the rear-side end portions of the first and second lower beams 12a and 12b is rotatably connected to the rear-side plate 2b. In this embodiment, the first and second lower beams 12a and 12b are rotatably supported by rotation shafts 14a and 14b, respectively, mounted to the rear-side plate 2b through mounting tools 141a and 141b, respectively. Each of the first and second lower beams 12a and 12b is rotatable about a rotation axis extending in a direction crossing (in this embodiment, substantially perpendicular to) the longitudinal direction of the associated one of the first and second lower beams 12a and 12b.

Further, as shown in FIG. 2, the front-side end portions of the first and second lower beams 12a and 12b is detachably connected to the front-side plate 2a by first and second stepped screws 15a and 15b, respectively. When the print belt 1 is exchanged, as shown in FIG. 9, after the print belt unit U is pulled out to the pulling-out position, the first and second stepped screws 15a and 15b are removed, and the first and second lower beams 12a and 12b are rotated in a downward direction. That is, the first and second lower beams 12a and 12b are rotatable about the rear-side end portions as rotation centers in a direction in which the front-side end portion sides are separated from the outer peripheral surface of the print belt 1. By this, the print belt 1 can be inserted into and extracted from the print belt unit U in the front-rear direction (widthwise direction of the print belt 1). Incidentally, the first and second lower beams 12a and 12b can be connected to the front-side plate 2a in the front-side end portions thereof by being rotated in a direction opposite to the above-described rotational direction.

Thus, according to this embodiment, the lower beam 12 is rotatable about the rear-side rotation shaft 14 when the stepped screw 15 of the front-side mounting portion is removed. For that reason, after the print belt unit U is pulled out, when the lower beam 12 is rotated, it is possible to ensure a space for permitting exchange of the print belt unit U.

Part (a) of FIG. 10 shows the front-side mounting portion of the lower beam 12 when the print belt unit U is in the print position and the lower beam 12 is not supported by the lower beam supporting roller 13. Part (b) of FIG. 11 shows the rear-side mounting portion of the lower beam 12 at that time. Further, part (a) of FIG. 12 shows a state of the lower beam 12 at that time.

On the other hand, part (b) of FIG. 10 shows the front-side mounting portion of the lower beam 12 when the print belt unit U is in a process of being pulled out from the print position toward the pulling-out position and the lower beam 12 is supported by the lower beam supporting roller 13. Part (b) of FIG. 11 shows the rear-side mounting portion of the lower beam 12 at that time. Further, part (b) of FIG. 12 shows a state of the lower beam 12 at that time.

As shown in part (a) of FIG. 10, in the front-side end portion of the lower beam 12 is provided with an engaging hole 16 (16a, 16b) engaging with the stepped screw 15. The engaging hole 16 is formed in a substantially vertically elongated hole shaft extended along (in this embodiment, substantially parallel to) the vertical direction. By this, a stepped portion of the stepped screw 15 engages with the engaging hole 16 with a degree of freedom with respect to the vertical direction. Further, as shown in part (a) of FIG. 11, the rear-side end portion of the lower beam 12 is provided with a rotation hole 17 (17a, 17b) engaging with the rotation shaft 14. The rotation hole 17 is formed in a substantially vertically elongated hole shaft extended along (in this embodiment, substantially parallel to) the vertical direction similarly as the above-described engaging hole 16. By this, the rotation shaft 14 rotatably engages with the rotation hole 17 with a degree of freedom with respect to the vertical direction.

As shown in part (a) of FIG. 12, when the print belt unit U is in the print position and the lower beam 12 is not supported by the lower beam supporting roller 13, the lower beam 12 in a suspended state by the stepped screw 15 and the rotation shaft 14. Further, between the lower beam 12 and each of the front-side plate 2a and the rear-side plate 2b, gaps G1 and G2 are formed, respectively. That is, at this time, the lower beam 12 does not contact a lower-side end portion (edge portion) of the front-side plate 2a and the rear-side plate 2b (i.e., is spaced from the edge portion). Incidentally, each of the front-side plate 2a and the rear-side plate 2b is constituted by using a plate-like member (metal plate). Further, an outer edge of each of the front-side plate 2a and the rear-side plate 2b is positioned on an outside than the outer peripheral surface of the print belt 1. On the other hand, as shown in part (b) of FIG. 12, during the pulling-out of the print belt unit U from the print position toward the pulling-out position, when the lower beam 12 is supported by the lower beam supporting roller 13, the following phenomenon occurs. At this time, the lower beam 12 receives an upward force from the lower beam supporting roller 13 and thus a state in which the above-described gaps G1 and G2 are narrowed (G1' and G2' in part (b) of FIG. 12), so that the lower beam 12 contacts the lower-side end portion (edge portion) of each of the front-side plate 2a and the rear-side plate 2b.

The case where there is no degree of freedom, with respect to the vertical direction between the lower beam 12 and each of the rotation shaft 14 and the stepped screw 15 will be considered. In this case, when a load is exerted on the lower beam 12, moment is generated between the front-side plate 2a and the stepped screw 15, and moment is generated between the rear-side plate 2b and the rotation shaft 14. For that reason, there is also a possibility that the front-side plate 2a and the rear-side plate 2b are distorted. Or, in some cases, there is also a possibility that the stepped screw 15 and the rotation shaft 14 are distorted. In this embodiment, as shown in part (b) of FIG. 2, the lower beam 12 receives a load in a direction substantially perpendicular to a thickness direction of each of the front-side plate 2a and the rear-side plate 2b, so that deformation of the front-side plate 2a and the rear-side plate 2b can be suppressed. Similarly, deformation of the stepped screw 15 and the rotation shaft 14 can be suppressed.

As described above, according to this embodiment, for example, also in a state in which the print belt unit U is only pulled out slightly, it is possible to suppress that the print belt unit U is largely moved downward by exceeding a tolerable amount. By this, it is possible to prevent that the print belt unit U cannot be pulled out and that the element of the print belt unit U such as the print belt 1 is broken.

### Other embodiments

In the above, the present disclosure was described based on specific embodiments, but the present disclosure is not limited to the above-described embodiments.

In the above-described embodiment, the case where the lower beam as the supporting beam is provided on the lower side of the print belt unit as the belt conveying device was described. However, the supporting beam may also be provided on a right side, a left side, or an upper side. For example, as shown in part (a) of FIG. 13, on the right side and the left side of the belt conveying device, a right beam 121 and a left beam 122 which are as the supporting beam can be provided, respectively. Further, supporting rollers 132 and 133 can be provided to the main body frame 7 so that the right beam 121 and the left beam 122 can be supported, respectively. Further, as shown in part (b) of FIG. 13, on the upper side of the belt conveying device, an upper beam 123 as the supporting beam can be provided. Further, a supporting roller 134 can be provided to the main body frame 7 so that the upper beam 123 can be supported. Arrangements of the supporting beams and the supporting rollers in the front-rear direction, mounting constitutions of the supporting beams and the supporting rollers, rotational directions of the supporting beams relative to the print belt, or the like may only be required to be in conformity to the above-described embodiment. Also, by such constitutions, an effect similar to the effect of the above-described embodiment can be obtained.

Further, in the above-described embodiments, the rotatable supporting member for supporting the supporting beam was the supporting roller, but the rotatable supporting member is not limited to the roller, and may also be an arbitrary rotatable member such as a wheel, a ball, or the like. The same also applies stop the grounding rollers and the rollers for the movement supporting units.

Further, in the above-described embodiment, the case where the belt conveying device is pulled out from the image forming apparatus main assembly for the purpose of exchanging the print belt was described as an example, but the belt conveying device may also be pulled out from the image forming apparatus main assembly for another purpose of performing an arbitrary operation (processing) such as maintenance.

Further, the image forming apparatus is not limited to the ink jet recording apparatus, but may also be an image forming apparatus of an electrophotographic type. Further, the belt conveying device is not limited to the print belt unit provided with the print belt used in the ink jet recording apparatus, but for example, may also be a photosensitive (member) belt, a transfer belt (recording material carrying belt, intermediary transfer belt), a fixing belt, and the like.

According to the present disclosure, it is possible to suppress that when the belt conveying device is pulled out from the image forming apparatus main assembly, the belt conveying device is largely moved downward by exceeding the tolerable amount.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-192529 filed on March 24, 2014, which is hereby incorporated by reference herein in its entirety.

What is claimed is:

1. An image forming apparatus comprising:
a main assembly;
an image forming portion provided to the main assembly and configured to form an image on a sheet;
a belt conveying device provided to the main assembly and provided with a rotatable endless belt for carrying and conveying the sheet and with a plurality of stretching rollers for stretching the belt, the belt conveying device being movable along a movement direction crossing a conveying direction of the belt between a first position for operating the belt conveying device and a second position on an outside of the main assembly relative to the first position;
a slide rail configured to movably support the belt conveying device along the movement direction, and extended along the movement direction from the first position toward the second position of the belt conveying device so as to pass through a region enclosed by an inner peripheral surface of the belt;
a slide rail supporting member configured to support the slide rail and supported by the main assembly on a side upstream of the belt conveying device with respect to the movement direction;
a supporting beam mounted to the belt conveying device and extended along the movement direction so as to oppose an outer peripheral surface of the belt; and
a rotatable supporting member mounted to the main assembly and configured to support the belt conveying device by supporting the supporting beam when the belt conveying device is moved from the first position toward the second position.

2. The image forming apparatus according to claim 1, wherein the supporting beam is provided below the belt.

3. The image forming apparatus according to claim 1, wherein the rotatable supporting member is provided in a position where the rotatable supporting member is on a side downstream of the supporting beam with respect to the movement direction in a state in which the belt conveying device is disposed in the first position.

4. The image forming apparatus according to claim 1, wherein the supporting beam includes a first end portion rotatably mounted to the belt conveying device and a second end portion removably mounted to the belt conveying device, and
wherein the supporting beam is rotatable so as to be separated from the belt in a case where the second end portion is removed from the belt conveying device.

5. The image forming apparatus according to claim 1, wherein the belt conveying device includes a first supporting structure for supporting upstream-side end portions of the plurality of stretching rollers with respect to the movement direction and a second supporting structure for supporting downstream-side end portions of the plurality of stretching rollers with respect to the movement direction,
wherein the supporting beam is provided below the belt,
wherein the rotatable supporting member is provided in a position where the rotatable supporting member is on a side downstream of the supporting beam with respect to the movement direction in a state in which the belt conveying device is disposed in the first position,
wherein the supporting beam includes a first end portion mounted to the first supporting structure so as to have a degree of freedom with respect to a vertical direction when the supporting beam is not supported by the rotatable supporting member,
wherein the supporting beam includes a second end portion mounted to the second supporting structure so as to have a degree of freedom with respect to the vertical direction when the supporting beam is not supported by the rotatable supporting member, and
wherein the supporting beam contacts a lower-side end portion of the first supporting structure and a lower-side end portion of the second supporting structure when the supporting beam is supported by the rotatable supporting member and is separated from the lower-side end portion of the first supporting structure and the lower-side end portion of the second supporting structure when the supporting beam is not supported by the rotatable supporting member.

6. The image forming apparatus according to claim 5, wherein each of the first supporting structure and the second supporting structure is constituted by a plate-like member.

7. The image forming apparatus according to claim 1, further comprising a movement supporting unit connected to an upstream side of the belt conveying device with respect to the movement direction and capable of supporting the slide rail supporting member by movement with the belt conveying device.

8. The image forming apparatus according to claim 1, wherein the slide rail is provided so as to penetrate through the region enclosed by the inner peripheral surface of the belt.

9. The image forming apparatus according to claim 1, wherein the belt conveying device carries and conveys the sheet on a surface of the belt opposing the image forming portion.

10. The image forming apparatus according to claim 1, wherein the image forming portion includes a recording head for ejecting a liquid for recording to the sheet conveyed by the belt.

11. The image forming apparatus according to claim 1, wherein in a state in which the belt conveying device is disposed in the second position, a whole of the belt is positioned outside the main assembly with respect to the movement direction.

12. The image forming apparatus according to claim 1, further comprising:
a base portion provided to the main assembly and configured to support the belt conveying device when the belt conveying device is positioned in the first position; and
a plurality of rotatable grounding members provided rotatably to the belt conveying device and configured to support the belt conveying device by being grounded to the base portion when the belt conveying device is positioned in the first position.

13. The image forming apparatus according to claim 12, wherein when at least one of the plurality of rotatable grounding members is positioned outside the base portion with respect to the movement direction, the rotatable supporting member supports the belt conveying device through the supporting beam.
